(19) United States
(12) Patent Application Publication
(10) Pub. No.: US 2005/0273984 A1
(43) Pub. Date: Dec. 15, 2005

(54) Locking quick-release collar

(76) Inventors: Ty Anderson, Maple Ridge (CA); Garnett RyShak, Port Moody (CA)

Correspondence Address: Clifford W. Vermette;Vermette & Co., Suite 230-200 Granville Street, Box 40 Granville Square, Vancouver, BC, V6C 1S4, CA

(21) Appl. No.: 10/865,856

(22) Filed: Jun. 14, 2004

(51) Int. Cl. F16L 33/00

(52) U.S. Cl. 24/279

(57) ABSTRACT

A lockable theft-resistant quick-release collar for use with, for example, bicycles. The collar comprises a ring and a lever. The lever pivots about one end of a skewer rod and the skewer rod passes through the end of the ring and into a flange that is integral with the ring. The lever has a camming action such that, as it is moved from the open position to the closed position the ring is compressed about the seatpost tube, thereby holding it firmly in place. The lever and ring have a tab and locking flange, respectively, that receives a lock so that the collar can be locked in the closed position. The end of the skewer rod distal from the pivot of the lever is inaccessible to bike thieves so that they are unable to open the collar without cutting the lock. The present invention therefore comprises an improved quick-release collar that acts as a deterrent against bike thieves.

### FIELD OF THE INVENTION

This invention relates to locking quick-release or cam-levered seatpost collars and clamps for bicycles.

### BACKGROUND OF THE INVENTION

Bicycle theft is one of the most common types of property crime. As any bicycle owner knows, one cannot leave one's bicycle unattended without first locking it, due to the risk of having it stolen. Even if the whole bicycle is not stolen, thieves may simply steal parts from unattended bicycles, leaving the locked bicycle itself behind. The most commonly stolen bike parts are those that are fixed with quick-release or cam-levered mechanisms, such as seats and front wheels.

The prior art is replete with locking mechanisms for bicycle parts, however, all of the prior art locking mechanisms suffer from one or more of the following drawbacks: 1) they are not suitable for use with quick-release mechanisms; 2) they require the addition of bulky or awkward parts to the bicycle; 3) they are easily bypassed by bicycle thieves; 4) they are difficult or slow to open, thereby making them difficult to use.

Accordingly, there exists a need in the art for a locking mechanism for quick-release collars that is easy to use, does not take up extra space or require additional components, and is not easily bypassed by thieves.

### SUMMARY OF THE INVENTION

The present invention comprises a lockable theft-resistant quick-release collar for use with bicycles, for example. The collar comprises a ring and a lever. The lever pivots about one end of a skewer rod and the skewer rod passes through the end of the ring and into a flange that is integral with the ring. The lever has a camming action such that, as it is moved from the open position to the closed position the ring is closed, thereby compressing an object within the ring, such as a seatpost of a bicycle.

The lever and ring have a tab and locking flange, respectively, that receive a lock so that the collar can be locked in the closed position. The end of the skewer rod distal from the pivot of the lever is inaccessible to bike thieves so that they are unable to open the collar without cutting the lock. The present invention therefore comprises an improved quick-release collar that acts as a deterrent against bike thieves.

The end of the skewer rod distal to the lever may be fixed to the collar.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a perspective view of a prior art seatpost collar;

FIG. 2 is a perspective view of the seatpost collar of the present invention in a closed position;

FIG. 3 is a perspective view of the seatpost collar of the present invention in an open position;

FIG. 4 is a top view of the seatpost collar of the present invention; and

FIG. 5 is a perspective view of the skewer rod of the present invention.

### DETAILED DESCRIPTION

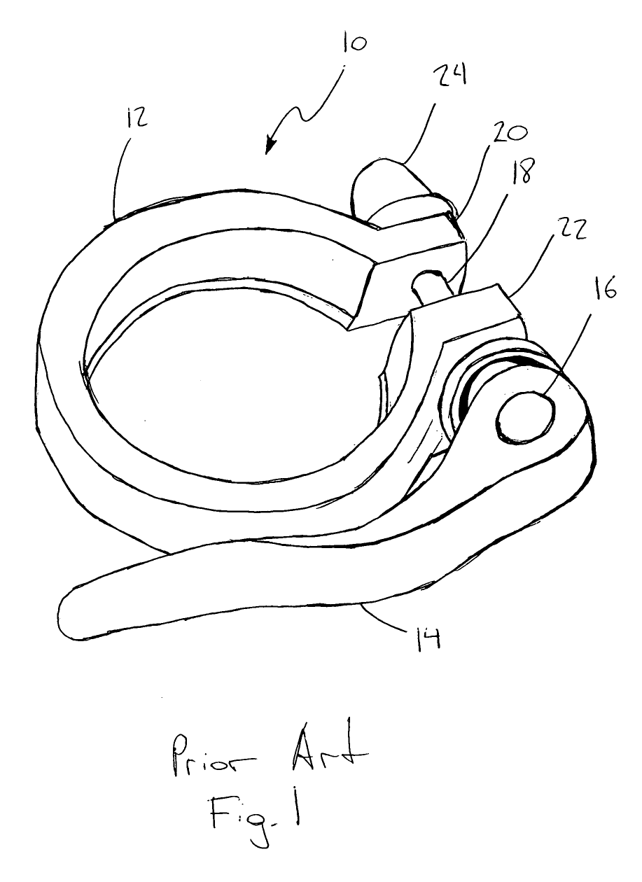

Referring to FIG. 1, a perspective view of a prior art quick-relese bicycle seatpost collar 10 is shown. The collar comprises a ring 12 and a lever 14. The lever 14 pivots about a skewer eye 16 attached to one end of a skewer rod 18. The skewer rod 18 passes through the ends 20, 22 of the ring 12, and the other end of the skewer rod 18 is affixed to a nut 24. The lever 14 has a camming action such that, as it is moved from the open position to the closed position (the lever 14 is shown in the closed position in FIG. 1) the ends 20, 22 of the ring 12 are forced closer together. When the collar 10 is placed about the seatpost tube portion of a bike frame the closing action of the lever 14 causes the ring 12 to compress the seatpost tube about the seatpost, thereby holding it firmly in place.

The skewer eye 16 may be threaded and the skewer rod 18 screwed thereinto. There are several known means for fixing the skewer eye 16 to the skewer rod 18. For example, the threaded hole of the skewer eye 16 may be coated with a substance to bond it to the skewer rod or, alternatively, a pin may be driven or screwed into an end of the skewer eye 16 and until it contacts the skewer rod.

Obviously, bike thieves can simply release the lever 14 on an unattended bicycle, thereby releasing the seat. Alternatively, in prior art embodiments having a mechanism that prevents release of the lever 14, the nut 24 can be unscrewed from the end of the skewer rod 18, thereby releasing the seat (this is easily achieved by applying pressure to the ring with, for example, vice grips, thereby releasing the tension on the skewer rod 18 and friction on the nut 24, making the nut 24 easily removable by hand).

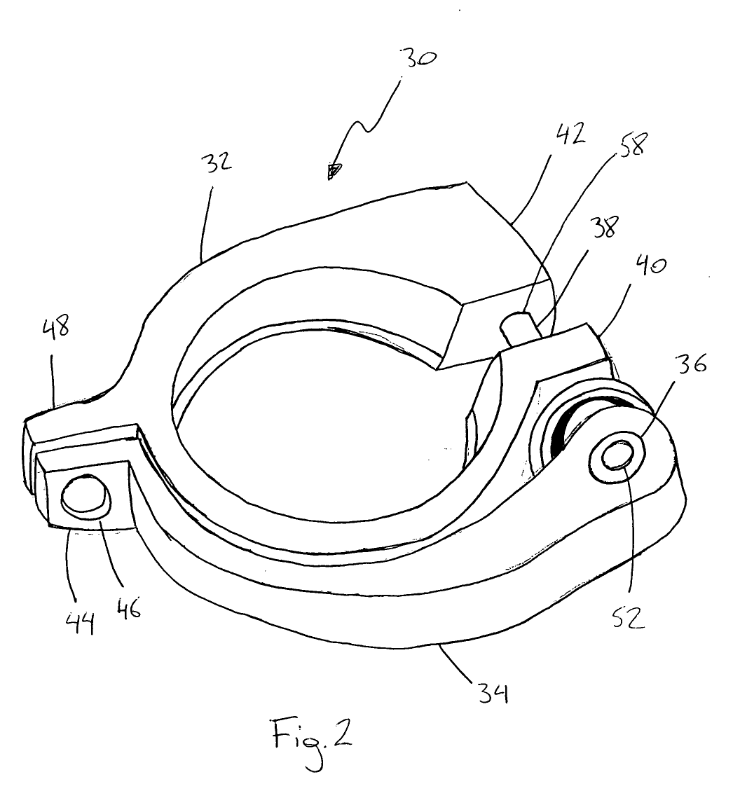

Referring to FIGS. 2, 3 and 4, a seatpost collar 30 according to the present invention is shown in open and closed configurations, respectively. The collar 30 comprises a ring 32 and a lever 34. The lever 34 pivots about a skewer eye 36 attached to one end of a skewer rod 38. The skewer rod 38 passes through the end 40 of the ring 32, and the other end of the skewer rod 38 extends into the flange 42 that is integral with the ring 32. The lever 34 has a camming action such that, as it is moved from the open position to the closed position the end 40 and the flange 42 are forced closer together thereby effectively decreasing the circumference of the ring 32. When the collar 30 is placed about the seatpost tube portion of a bike frame the closing action of the lever 34 causes the ring 32 to compress the seatpost tube about the seatpost, thereby holding the seatpost firmly in place.

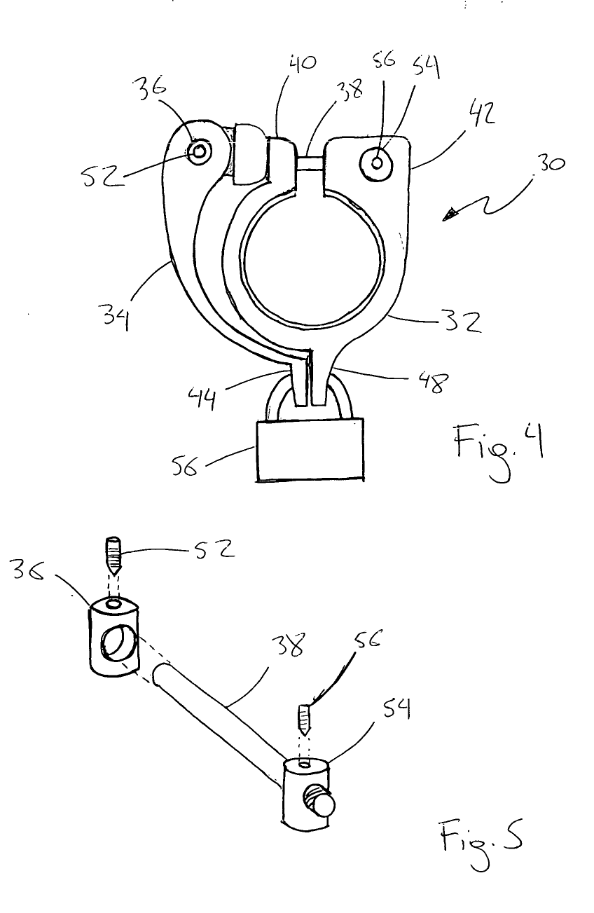

The end of the lever 34 has a tab 44 having a hole 46 therethrough. When the lever 34 is in the closed position, as is shown in FIGS. 2 and 4, tab 44 is positioned proximate locking flange 48 such that the hole 46 is aligned with the hole 50 through the locking flange. The alignment of the holes 46, 50 allows a lock to be passed therethrough such that the lever 34 may be locked in the closed position.

Referring to FIG. 4, a lock 56 is shown passing through flange 48 and tab 44.

Referring to FIGS. 4 and 5, lever arm 34 and skewer eye 36 are fixed to the skewer rod 38 by a pin 52. The pin 52 may be a screw which is screwed into a hole in the end of the skewer eye 36 until it contacts the surface of the skewer rod 38. Alternatively, the pin 52 may be a nail which is driven through the hole in the end of the skewer eye 36 until it contacts skewer rod 38. The friction between the pin 52 and the skewer rod 38 locks the lever 34 to the skewer rod 38 so that it may not be removed. In other words, bike thieves are not able to simply unscrew the lever 34 from the skewer rod 38.

The embodiments of FIGS. 4 and 5 also comprise a second skewer eye 54. In this embodiment, the flange 42 has a hole drilled therethrough that receives the second skewer eye 54. The second skewer eye 54 has a threaded hole that receives and end of the skewer rod 38. A pin 56 through the end of the second skewer eye 54 locks the skewer rod 38 relative to the skewer eye 54 so that the skewer rod 38 may not be unscrewed.

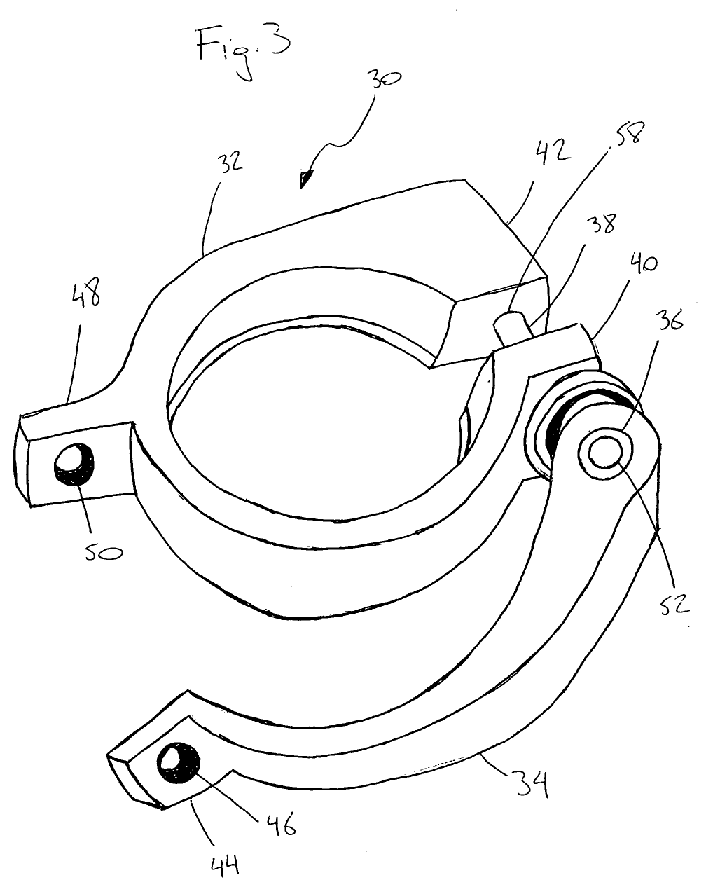

FIGS. 2 and 3 show an alternative embodiment of the invention that does not incorporate a second skewer eye. Instead, in the embodiment of FIGS. 2 and 3, the skewer rod 38 is inserted into a hole 58 in the flange 42. The hole 58 and the end of the skewer rod 38 are threaded such that the skewer rod 38 is screwed into the hole 58. By turning the skewer rod 38 the size of the ring 32 can be adjusted. In an alternative embodiment, a bonding material, such as an epoxy resin, may be placed in the hole 58 prior to insertion of the skewer rod 38. The bonding material would lock the skewer rod 38 into place so that it cannot be removed from the hole 58.

When locked, the embodiments of FIGS. 2-5 cannot be bypassed by bike thieves without cutting the lock. In contrast, the prior art quick release clamps, such as that shown in FIG. 1, need only be squeezed with a pair of vise grips so that the nut 24 can be loosened. Accordingly, the present invention provides an improved, theft-resistant quick-release collar for use on bicycles and in other applications.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

1. A lockable quick-release collar comprising:
a) a skewer rod having a first end and a second end;
b) a C-shaped ring having a first end and a second end, said first end having a hole for passing said skewer rod, and said second end having a flange into which said first end of said skewer rod is inserted, said ring additionally having a locking flange;
c) a cam lever pivotally mounted to said second end of said skewer rod such that when said cam lever is in a closed position said first and second ends of said ring are forced toward one another, said cam lever having a locking tab operative to engage said locking flange of said ring when said lever is in the closed position;
wherein said flange encloses said first end of said skewer rod so that said first end of said skewer rod is inaccessible and wherein said skewer rod is engaged within said flange to prevent longitudinal movement of said skewer rod within said flange;
and wherein said locking flange and said locking tab have corresponding holes operative to pass a lock when said locking flange and said locking tab are engaged.

2. The lockable quick-release collar of claim 1, wherein said flange comprises a hole into which said first end of said skewer rod is inserted, and said hole and said first end of said skewer rod are threaded in a complementary manner such that said first end of said skewer rod is screwed into said hole in said flange.

3. The lockable quick-release collar of claim 1, wherein said first end of said skewer rod is threaded and wherein said flange comprises a drilled hole operative to receive a skewer eye, said skewer eye having a threaded hole therethrough operative to receive said first end of said skewer rod.

4. The lockable quick-release collar of claim 1, wherein said locking flange is collinear with a diameter of said ring.

5. The lockable quick-release collar of claim 3, wherein said skewer rod is fixed relative to said skewer eye by a pin inserted into a hole in an end of said skewer eye.
